(19) United States
(12) Patent Application Publication
(10) Pub. No.: US 2009/0187506 A1
(43) Pub. Date: Jul. 23, 2009

(54) System in which new production creates new money

(76) Inventor: Boris Isaacson, Buckey, AZ (US)

Correspondence Address: Michael A. Painter, Esq., Suite 850, 8484 Wilshire Boulevard, Beverly Hills, CA, 90211, US

(21) Appl. No.: 12/383,413

(22) Filed: Mar. 24, 2009

Related U.S. Application Data
(63) Continuation of application No. 10/684,196, filed on Oct. 14, 2003, now abandoned.

(51) Int. Cl. G06Q 40/00

(52) U.S. Cl. 705/39

(57) ABSTRACT

An economic system includes a method of keeping consumption equal to production by creating new money only in response to new production. The method includes the steps of an employer ordering new production including one of a new good and/or service and an earner performing the new production for the employer. The earner's account is credited new money for the value of their contribution of the new production. The employer's account is debited a like amount of money as the amount of the new money equal to the company's profit from the new production by a clearing house and a percent of the debited like amount of money is distributed by a prearranged formula to prevailing governments in lieu of taxes.

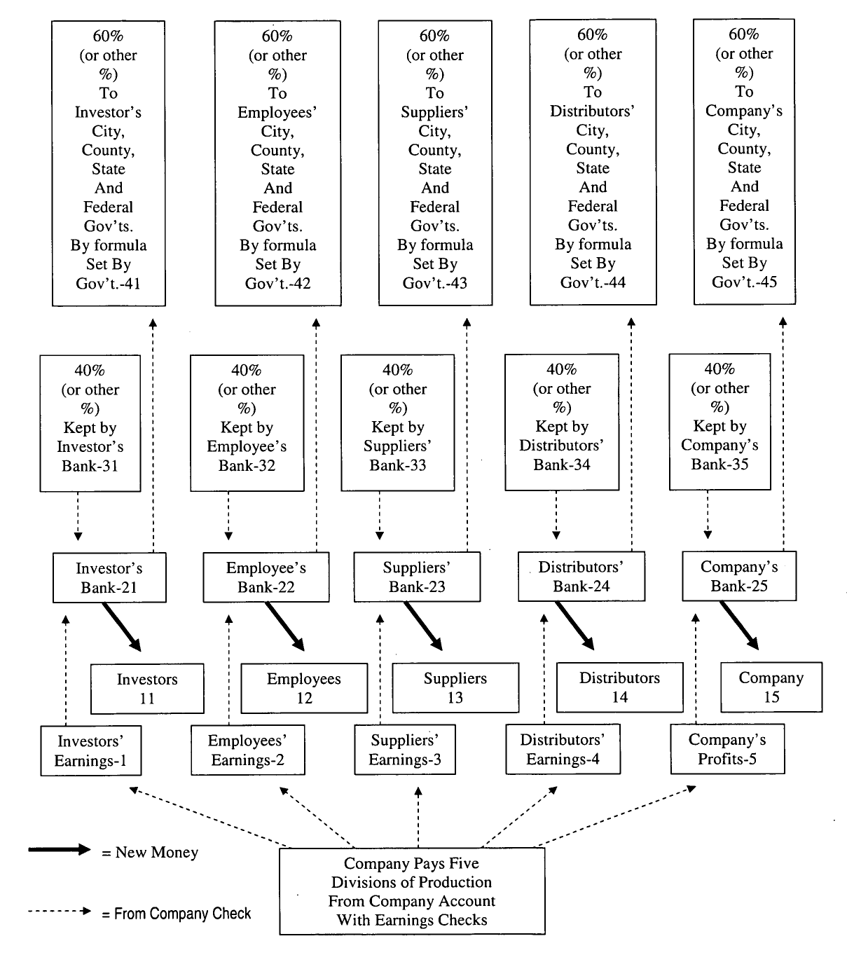

### FIELD OF THE INVENTION

This invention generally relates to an economic system in which new production creates new money.

### BACKGROUND OF THE INVENTION

Economies around the world are constantly plagued with boom and bust, prosperity and recession. Considerable economic suffering, including unemployment, poverty, hunger, recession, foreclosure, repossession, homelessness bankruptcy and limited economic growth, are the result of current economies because they have no way to keep consumption equal to production. Economists have said for over 100 years that in order for an economy to be good, consumption, the stuff we buy, must equal production, the stuff we make. The various woes mentioned are at an all time high with no end or improvement in sight because our present economy cannot keep consumption equal to production.

The common problem with current economies is that the money supply is always much smaller than production. Too little money in the money supply, in circulation, causes recession, which in turn causes the aforementioned woes as well as restricting economic growth. No economy will be successful until a process is in place that will insure that consumption will always equal production. Today current economies have no way to keep consumption equal to production.

Goods and services are purchased with money. It is impossible for consumption to equal production if the money supply is smaller than the production. Today as new goods and services are produced an imbalance is created because no new money is created to match that production. According to the 2007 edition of the New York Times Almanac the current gross domestic product stands at 14 trillion dollars here in the United States, while the current money supply is a mere 1.5 trillion dollars resulting in all the economic woes mentioned above from poverty and hunger to foreclosure and bankruptcy. Yes, money is reusable; however, once an individual spends it, it is gone for him or her. It is only useful thereafter for someone else. In order for consumption to equal production there must be the same amount of money in circulation as there are goods and services in the marketplace. This invention describes a way to keep the money supply equal to production so that consumption can equal production.

The value of all production is determined by the earnings of all the people and companies involved in that production, and nothing else. It is the earnings of the five divisions of production, and only the earnings. The value of all production is the accumulated total of the earnings of the five divisions of production: the earnings of the companies, their investors, their employees, their suppliers and their distributors. There is no way in our present economy to keep the money supply equal to production so that consumption can equal production.

Today new money is created in the lending process which has the resultant effect of actually shrinking and not increasing the money supply. For example, the money supply is increased by one hundred thousand dollars when a thirty year one hundred thousand dollar real estate loan is made. However, when the loan is repaid, three hundred thousand dollars have been paid back, netting a shrinkage of 200 thousand dollars in the money supply. Every loan actually shrinks the money supply by the amount of interest necessary to pay back the loan because as the loan is made only the principal is created and no new money is created to pay the interest. The interest has to come out of the money supply because that is the only place it exists. This shrinkage of the money supply further adds to the economic woes mentioned above. This invention ends the drain on the money supply caused by the lending process.

Another drain on the money supply is the tax system. Taxes have always been a deterrent to economic prosperity because taxes unduly reduce purchasing power of consumers. Taxes deplete the money supply because that is the only place consumers can get money. Taxes, the conventional method of funding government, not only restrict trade and economic growth but have proven that taxes do not sufficiently fund governments, which is evidenced by massive current government debt world-wide. Taxes are a major contributing cause of conditions that perpetuate increased unemployment, poverty, hunger, bankruptcy, foreclosures, repossession and homelessness while they restrict economic growth. Taxes are not an acceptable or adequate means for government support because they cannot provide sufficient funding without depleting the money supply, thereby creating a downward spiral of effects ending in the above listed woes.

It would be highly advantageous, therefore, to remedy the foregoing and other deficiencies inherent in the prior art.

Accordingly, it is an object of the present invention to provide a new and improved economic system in which only new production creates new money.

It is another object of the present invention to provide a new and improved economic system in which new money is created only in response to new earnings because it is only new earnings that can determine the value of new production

It is another object of the present invention to provide a new and improved economic system that eliminates taxes and other tax related costs as we know them which further prevents consumption from equaling production.

### SUMMARY OF THE INVENTION

The above objects and others are realized in an economic system including a method of keeping consumption equal to production by creating new money only in response to new earnings, which determines the value of new production. The value of all production is the accumulated earnings of the five divisions of production: the company, its employees, its investors, its suppliers and its distributors. The method includes the steps of an employer ordering new production including one of a new good and/or service and employees, investors, suppliers and distributors performing the new production for the employer to create earnings for the five divisions of production above. The employees, investors, suppliers, distributors and the company's profit accounts are credited new money for the value of the new production. The employer's account is debited a like amount of money as the amount of the new money by a clearing house and/or bank. 60 percent (or other preset percentage) of the debited like amount of money is distributed by a prearranged formula by the employees, investors, suppliers and distributors and company's banks or the clearing house to the employees, investors, suppliers, distributors and company's city, county, state and federal governments in lieu of taxes. The remaining 40 percent (or other preset percentage) is kept by the employees' bank, investors' bank, suppliers' bank, distributors' bank and company's bank to support the cost of bank operations.

### BRIEF DESCRIPTION OF THE DRAWING

The foregoing and further and more specific objects and advantages of the instant invention will become readily apparent to those skilled in the art from the following detailed description of a preferred embodiment thereof taken in conjunction with a single drawing illustrating in flow chart form an exemplary economic system in accordance with the present invention.

### DETAILED DESCRIPTION OF A PREFERRED EMBODIMENT

The main objective of the present economic system is to create an economy wherein consumption always equals production and thereby can eliminate all recession, poverty, unemployment, hunger, homelessness, foreclosure, repossession and bankruptcy generated by a short money supply. In order for all new production, all new goods and services, to equal consumption there must be a corresponding and equal creation of new money so that all of the new goods and services can be consumed. It is only logical that a money supply smaller than the worth of new goods and services produced prevents the consumption of all the new goods and services. Basically, the economic system described herein provides for the creation of new dollars (or the units used in other countries) whenever new goods and services, production, are produced, thereby allowing the consumption of all of the new goods and services to be effected. In order for consumption to equal production, new dollars must be created equal to the new goods and services being produced.

The total value of all new goods and services are necessarily determined by the five divisions of production; the total of the earnings of the investors, the company/employer, the employees, the company's suppliers and the company's distributors. It starts with the investor who earns his money by investing it in some production of a good and/or service. Then the company/employer earns a profit by producing those goods and/or services. Then, the employees earn wages for their contribution to the production of those goods and/or services. Finally the company's suppliers and distributors accrue earnings for their contribution to the production. The total value of all goods and services logically equals the earnings of all five divisions of production, the earnings of the investor, the earnings of the company, the earnings of the employees, and the earnings of the suppliers and the distributors.

The term “earner” includes one or more of the five divisions of production, i.e. the investor, the company (profits), the employees, the suppliers, and the distributors. The term “employer” is generic for any person responsible for ordering or instigating any new production. Also, the terms: “employee's account” and “employee's bank”; “employer's account” and “employer's bank”; and clearing house may be interchangeable and, also, any or all of the units may perform the functions of one or more of the other units alternatively or in lieu of.

Turning now to the single drawing, an exemplary economic system in accordance with the present invention is illustrated. Company pays all five divisions of production (i.e. investors 11, employees 12, suppliers 13, distributors 14, and company profits 15) with earnings checks: 1, 2, 3, 4 and 5. Investors' bank 21, employees' bank 22, suppliers' bank 23, distributors' bank 24 and companies' bank 25 credit each account the amount of the check without depositing funds into those respective accounts. This act of crediting deposits without depositing any money into the respective accounts literally creates new money that never existed before, similar to the way new money is created in the lending process. Investors 11, Employees 12, Suppliers 13, Distributors 14 and Company Profits 15 thereby receive new money from Investors' Bank 21, Employees' Bank 22, Suppliers' Bank 23, Distributors' Bank 24 and Company's Bank 25 respectively. Banks 21 through 25 cash checks through a clearing house and send 60 percent (or other percentage determined by the government) of the earnings to each respective earners' city, county, state and federal government by a formula set by the government. This 60 percent would increase government revenue by 2 to 3 times current levels provided by the current tax method. The remaining 40 percent (or other percentage determined by the government) is kept by those respective banks, 21 through 25, as payment for keeping the money supply equal to production.

Under this economic system all earnings of investors 11, employees 12, suppliers 13, distributors 14 and the company profits 15 are paid with new money as per above issued by their respective banks: investors' bank 21, employees' bank 22, suppliers' bank 23, distributors' bank 24 and company's bank 25. Here it will be understood that investors 11, employees 12, suppliers 13, distributors 14 and the company 15 represents any and all entities that are responsible for new production. Also, investors' bank 21, employee's bank 22, suppliers' bank 23, distributors' bank 24 and company's bank 25 represents any financial structure with which investors 11, employees 12, suppliers 13, distributors 14 and company 15 does business and may include banks, credit unions, etc. Employee's bank 12 credits the account of employee 12 exactly in the amount of the earnings of employee 12 (the amount of special Money Creating Check or other check) without debiting the account of a payer or employer. The simple act of crediting the account of employee 12 without debiting the account of employer 15 literally creates new money adding to the nation's money supply. The banks for the other four divisions of production, the investors' bank 21, companies' bank 25, suppliers' bank 23 and distributors' bank 24, do likewise.

No new money should be created in any other way, form, or process. To keep the money supply equal to production, thereby allowing consumption to equal production, no new money should be allowed to be created in any other fashion or process. Creating new money in any other way will upset the equality between consumption and production. This newly created money keeps the nation's money supply equal to the nation's production thereby insuring that consumption can and will always equal production.

Up to this point, no funds have been debited from banks 21 through 25. After the new money is created, for example, by crediting into the account or bank 22 of employee 12, employee's bank 22 sends the special Money Creating Earnings Check or other check 2 to a central clearing house (not shown) and the clearing house debits employer's bank or account 25 the same amount as the amount on special Money Creating Earnings Check or other check 2 given to employee 12. The money debited employer's/company's bank or account 25 is then sent to the prevailing governments 45 as described below. In the United States there are four divisions of government that need to be funded, city, county, state, and federal. This same process is repeated for each of the other four divisions of production, the company, investor, supplier and distributor.

Each time any division of production is paid in this manner the account of the company 25 is debited a like amount of money by either employee's bank 22, employer's bank 25, investor's bank 21, supplier's bank 23 or distributor's bank 24, or a central clearing house. A 40 percent (or other percentage) portion agreed upon by the various forms of prevailing governments (e.g. city, county, state, and federal in the U.S. of A.) remains with employer's bank 25 for the sustenance of employer's bank 25. The remainder, 60 percent (or other percentage) is sent by a predetermined formula by either employer's bank 25, employee's bank 22, etc., etc., or a clearing house to the prevailing governments 41 through 45 (e.g. city, county, state, and federal in the U.S. of A.) of each division of production in lieu of taxes. This invention generates two to three times more revenue for government and thereby eliminates the need for taxes and other government fees.

No single division of government should collect the revenue from the present Economic System. If any one division of government collected the revenue then all of the other divisions would be looking to that division for funding. No division of government should look to any other division of government for its funding. By pre-determining the percentages that each government division should receive, each division of government can receive their share of the revenue automatically. As each account is debited each of the divisions of government will receive their fair share on an on-going and not fiscal basis. Here it will be noted that such funding gives government approximately two to three times the revenue that governments get under today's conventional tax methods and provides that no division of government shall depend on any other division for funding.

An additional benefit due to this invention is that it is in the best interests of each division of government to improve the economy because any improvement in the economy means additional revenue to the government. It is an established fact that debt has a damaging effect on any economy. Banks also will have the incentive of improving the economy similarly because any improvement in the economy means additional revenue for the banks. It should be noted that the current economic method works in an opposite direction, stifling the economy, because a shrinking of the money supply stimulates borrowing by individuals, companies and governments, good for the banks and bad for the economy.

Small businesses and self-employed individuals participate in the Economic System basically the same as described above. When a small business owner/self-employed individual pays himself for work he has done running his business, he will pay himself with the same special Money Creating Check or other check. Whenever small businessman, Joe, takes profits out of the business, such withdrawal of profits are the same as his pay for running his business and are treated the same as any other new production done. Funds from the business owner's account are debited and sent to the government the same as when any other division of production is paid.

Corporations participate in the Economic System basically the same as described above. Corporations will pay employees, suppliers, investors, distributors and themselves as explained above and executives will- also be paid in the same way.

Investors participate in the Economic System basically the same as described above. An investment is a purchase with the expectation of gain. Like any other purchase, investments are made with existing money, not new money. However, when profit is made on an investment that profit is a direct result of the investor's efforts, however little time they may have consumed. That profit is a result of the investor's input to production using his investment money. The profit is treated as payment for new production done and is paid for with special Money Creating Check or other check. Thus, new money is created to compensate the investor and a like amount goes to the government 41 directly from the investor's bank 21.

When an investment results in a loss, it is no different than a shopkeeper having to discard obsolete or spoiled goods that cannot be sold. The goods the shopkeeper has to dispose of do not affect the Economic System. Also, the loss resulting from an investment does not affect the Economic System since losses do not create new money.

Sales of products and services are treated in the Economic System basically the same as described above. When a product or service is sold, aside from the salesperson's own work in making the sale, no new money is created. When a customer buys a product or service he or she is spending existing money. No new money is involved in the purchase. Yes, the salesperson has contributed to new production in making the sale and new money is created through the Economic System when he or she is paid a salary or commission. Commissions are compensation for sales made. Sales made are the same as new production performed. While the commission may be made in minutes, hours, or day, time is not a factor. When the commission is paid it is treated under the Economic System as new production performed and is paid for with special Money Creating Check or other check.

Government employees are different than other employees. While their work is very essential and valuable it does not add to the marketplace or the total marketable wealth of the nation. The wealth of the market place is the sum total of the earnings of all the people and companies responsible for the production of all the saleable goods and services in the nation's market place. Government employees do not add to saleable goods or services and therefore their work does not create new money in the Economic System. Government employees, very logically, should be paid for with the money turned over to governments from all the marketable production performed by people in the private marketable sector. If government employees were paid with ‘new’ money the money supply would be overly increased and cause inflation. In this way the revenues collected by government do not become inflationary and the balance between production and consumption remains equal. Also, government purchases of goods, services, real estate, etc. are no different than purchases made by individuals. All purchases do not create new money and are bought with existing money.

Gifts and inheritances are not new production, do not create new money, and are paid for with existing money. Gifts and inheritances have no effect on the Economic System. The free exchange of existing money is not impaired. The free exchange of existing money does not alter the total wealth of anything.

Educators, teachers, coaches, etc. work with students and are paid the same as any other employees. However, the work students do in getting their education cannot be paid with new money unless they are paid to learn as in a company sponsored educational program.

Thus, a new and improved economic system has been disclosed in which new money is created only by new production. The new and improved economic system prevents recession and provides for maximum growth of the economy. Also, the new and improved economic system eliminates taxes, government fees and other costs as we know them and keeps consumption equal to production.

Various changes and modifications to the embodiment herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. A method to maintain the equality of the value of all goods and services produced and the value of all goods and services consumed in an economic system including an employer, employees, a supplier, a distributor and an investor comprising the steps of:
(a) determining the value of orders by an employer for new goods and services;
(b) crediting an employer's account with the value of the earnings of the employer from orders for new goods and services;
(c) determining the value of the earnings of employees for services rendered to the employer for the production of new goods and services produced for the employer;
(d) crediting the employees' account with the value of the earnings for the services rendered by the employees for the production of the new goods and services produced for the employer;
(e) debiting the employer's account by an amount equal to the value of the earnings for the services rendered by the employees for the production of the new goods and services produced for the employer; and
(f) paying from the employer's account to a government agency a predetermined percentage of the value of the earnings received for the services rendered to produce the new goods and services for the employer whereby the money supply of the economic system will be maintained equal to the value of all goods and services produced so that the value of goods and services produced equals the value of all goods and services consumed.

2. A method to maintain the equality of the value of all goods and services produced and the value of all goods and services consumed as defined in claim 1 wherein the amounts paid from an employer's account to a governmental agency include amounts paid to agencies of cities, counties, states and the federal government.

3. A method to maintain the equality of the value of all goods and services produced and the value of all goods and services consumed as defined in claim 1 wherein the amount paid from the employer's account to a governmental agency is paid in lieu of taxes.

4. A method to maintain the equality of the value of all goods and services produced and the value of all goods and services consumed in an economic system including an employer, employees, a supplier, a distributor and an investor comprising the steps of:
(a) determining the value of orders by an employer for new goods and services;
(b) crediting an employer's account with the value of the earnings of the employer from orders for new goods and services;
(c) determining the value of the earnings of employees for services rendered to the employer for the production of new goods and services produced for the employer;
(d) crediting the employees' account with the value of the earnings for the services rendered by the employees for the production of the new goods and services produced for the employer;
(e) debiting the employer's account by an amount equal to the value of the earnings for the services rendered by the employees for the production of the new goods and services produced for the employer; and
(f) paying from the employer's account to city, county, state and federal agencies a percentage determined by said agencies of the value of the earnings received for the services rendered to produce the new goods and services for the employer whereby the money supply of the economic system will be maintained at a level which will insure that the value of all goods and services produced is equal to the value of all goods and services consumed.
